(19) United States
(12) Patent Application Publication
(10) Pub. No.: US 2019/0216046 A1
(43) Pub. Date: Jul. 18, 2019

(54) HOUSING FOR REDUCING AGRESSION WITHIN RODENT POPULATIONS

(71) Applicant: ARIZONA BOARD OF REGENTS ON BEHALF OF THE UNIVERSITY OF ARIZONA, Phoenix, AZ (US)

(72) Inventors: Bret Tallent, Phoenix, AZ (US); Jonathan Lifshitz, Phoenix, AZ (US)

(21) Appl. No.: 16/312,943

(22) PCT Filed: Jun. 27, 2017
(86) PCT No.: PCT/US2017/039507

§ 371 Date: Dec. 21, 2018

Related U.S. Application Data
(60) Provisional application No. 62/355,584, filed on Jun. 28, 2016.

(51) Int. Cl. A01K 1/03; A01K 1/00

(52) U.S. Cl. CPC A01K 1/031; A01K 1/0011

(57) ABSTRACT

Disclosed herein are housings, systems, kits and methods for reducing aggression among rodents. A laboratory rodent housing may have, for example, a common milieu area and one or more segregated individual nesting areas.

### BACKGROUND

### Field

The present disclosure includes housing, systems, kits and methods for reducing aggression among rodents stored within a common housing.

### Description of the Related Art

Both in the wild and in domesticated situations rodent populations fight for a multitude of reasons. For example, mouse populations have been known to fight for dominance, resources, territory, breeding, or aberrant behavior. Some animal models used for research, such as mice with traumatic brain injury are more likely to be aggressive. Data indicate that the presence of a cage divider reduces aggression among laboratory animals, thereby improving animal welfare. In a laboratory environment, aggressive interactions between rodents may exceed normal levels known to experts in the field leading to negative effects both on the well-being of the animals and on the validity of experimental results.

Improved devices and techniques for reducing such aggression are needed.

### SUMMARY OF CERTAIN INVENTIVE ASPECTS

In a first aspect, housings, systems, kits and methods are disclosed. Some embodiments are related to a laboratory rodent housing having a common milieu area and segregated individual nesting areas.

In a second aspect, the present disclosure provides housing, systems, kits and methods for reducing aggression among laboratory rodents stored within a common housing.

In a third aspect, housings, systems, kits and methods are disclosed that are related to a laboratory rodent housing having a common milieu area and segregated individual nesting areas.

In a fourth aspect, a rodent housing is disclosed that includes, for example, a common milieu area and two or more segregated individual nesting areas. In some embodiments, the two or more segregated individual nesting areas are separated by dividing walls. In some embodiments, the rodent housing further includes a common water and food area. In some embodiments, the housing is transparent. In some embodiments, the dividing walls are transparent. In some embodiments, the dividing walls are formed of cardboard or corrugated paper. In some embodiments, the material composition of the housing and the dividing walls is plastic.

In a fifth aspect, a rodent housing is disclosed that is not limited to a particular number of segregated individual nesting areas. In some embodiments, the number of segregated individual nesting areas is less than 10. In some embodiments, the number of segregated individual nesting areas is less than 5. In some embodiments, the number of segregated individual nesting areas is 3. In some embodiments, the number of segregated individual nesting areas is 2, 3, 4, 5, 6, 7, 8, 9, 10, 11, 12, 13, 14, 15, 16, 17, 18, 19, 20 or any range defined by any of the aforementioned values.

In a sixth aspect, a housing is disclosed that is not limited to housing a particular type of rodent or small animal. In some embodiments, the rodents include, but are not limited to, rats, mice, guinea pigs, hamsters, etc. In some embodiments, the rodents are laboratory rodents. In some embodiments, the rodents are pet rodents.

In a seventh aspect, methods of reducing aggression within rodents residing within group housing are disclosed. In some embodiments, the method includes providing a housing and domiciling two or more rodents within the housing. In some embodiments, the number of domiciled rodents has no relation to the number of segregated individual nesting areas. In some embodiments, the number of rodents equals the number of segregated individual nesting areas. In other embodiments, the number of rodents or the number of segregated individual nesting areas is greater than the other.

In an eighth aspect, a housing is generated through modifying a rodent housing having only a common milieu. In some embodiments, the conversion includes positioning of one or more dividing walls within the rodent housing having only a common milieu such that two or more segregated individual nesting areas are generated.

In a ninth aspect, a dividing wall for modifying a rodent housing having only a common milieu is disclosed. In some embodiments, a dividing wall is configured for positioning within a rodent housing having only a common milieu such that segregated individual nesting areas are generated.

In a tenth aspect, kits including of one or more of such dividing walls and a rodent housing having only a common milieu are disclosed.

In an eleventh aspect, a system for reducing aggression within a small animal population is disclosed. The system includes a cage configured to house two or more small animals, the cage including a floor and walls extending substantially perpendicular from the floor, a common milieu area within the cage, two segregated individual nesting areas within the cage, and a removable dividing wall positioned within the cage substantially perpendicular to the floor and separating the two segregated individual nesting areas from each other. In some embodiments, the system includes three segregated individual nesting areas within the cage including a first removable dividing wall positioned between a first nesting area of the three segregated individual nesting areas and a second individual nesting area of the three segregated individual nesting areas and a second removable dividing wall positioned between the second individual nesting area of the three segregated individual nesting areas and a third individual nesting area of the three segregated individual nesting areas.

In some embodiments, the dividing wall is opaque. In some embodiments, the cage is transparent. In some embodiments, the dividing wall is transparent or translucent. In some embodiments, the dividing wall is configured to provide line-of-sight evasion between a dominant small animal on a first side of the dividing wall and a subordinate small animal on a second side of the dividing wall. In some embodiments, if a dominant small animal is within line-of-sight of a submissive small animal then the dominant small animal will exhibit aggressive behaviors. In some embodiments, the system further includes a lid affixed to the top of the walls of the cage. In some embodiments, the lid is transparent. In some embodiments, the floor includes a substantially flat surface. In some embodiments, the floor is substantially rectangular. In some embodiments, the walls extended substantially perpendicular upward from the floor. In some embodiments, the walls extend upward from the floor such that the perimeter of the top of the walls is larger than the perimeter of walls where they attach to the floor. In some embodiments, the dividing wall has a hole between the two segregated individual nesting areas. In some embodiments, the system further includes a common water and food area. In some embodiments, the removable dividing wall is formed in a substantially rectangular plate shape. In some embodiments, the removable dividing wall is formed of cardboard or corrugated paper or corrugated cardboard. In some embodiments, both the cage and the dividing walls are formed of plastic. In some embodiments, an edge of the removable dividing wall contacts one of the walls in a substantially perpendicular fashion. In some embodiments, an edge of the removable dividing wall is positioned substantially perpendicular to, but does not contact, one of the walls while an opposite edge of the removable dividing wall extends less than half of the length of the cage. In some embodiments, the removable dividing wall is held in place by a feed hopper. In some embodiments, the removable dividing wall is held in place by the lid. In some embodiments, each of the two segregated individual nesting areas includes a square of compressed cotton. In some embodiments, the two segregated individual nesting areas each have access to the common milieu area within the cage such that a first small animal from the small animal population can pass from the common milieu area into either of the two segregated individual nesting areas. In some embodiments, the two segregated individual nesting areas are connected by the common milieu area within the cage. In some embodiments, the small animal is a rodent. In some embodiments, the rodent is selected from the group consisting of a rat, a mouse, a hamster and a guinea pig. In some embodiments, the small animal is a mouse.

In a twelfth aspect, a method of reducing aggression between rodents residing within a common housing is disclosed. The method includes providing a transparent housing having a floor with border walls attached to and extending upwardly from the floor, the transparent housing having a common milieu area and two individual nesting areas and placing two or more rodents within the housing.

In some embodiments, the number of domiciled rodents has no relation to the number of segregated individual nesting areas. In some embodiments, the method further includes placing a removable wall between the two individual nesting areas, the removable wall formed in a plate shape and positioned substantially perpendicular to the floor and substantially perpendicular to one of the boarder walls. In some embodiments, the removable wall does not contact the one of the border walls. In some embodiments, the method further includes placing a square of compressed cotton in each of the two individual nesting areas. In some embodiments, the method further includes placing a cotton mat or toilet paper roll within the housing for the rodents to chew on and/or entertain themselves. In some embodiments, the removable wall is formed of a corrugated paper, cardboard or corrugated cardboard such that the rodents may chew on the removable wall and/or make additional nesting material from the removable wall. In some embodiments, the removable wall is configured to provide line-of-sight evasion from a dominant rodent within one of the segregated individual nesting areas and at least one of the remaining segregated individual nesting areas.

In a thirteenth aspect, a dividing wall for modifying a rodent housing having only a common milieu is disclosed. In some embodiments, the dividing wall is configured for positioning within a rodent housing having only a common milieu such that segregated individual nesting areas are generated and the dividing wall provides line-of-sight evasion from a dominant rodent to a subordinate rodent in different segregated individual nesting areas on opposite sides of the dividing wall.

In a fourteenth aspect, a kit is disclosed. The kit may include, for example, a rodent housing having a floor and border walls defining an inner perimeter; a common milieu within the inner perimeter; a lid for placing over a top of the rodent housing; and a removable dividing wall configured for placement within the inner perimeter to define at least two individual nesting areas within the inner perimeter.

In some embodiments, the removable dividing wall is opaque. In some embodiments, the removable dividing wall is configured to be held in place by the lid.

In some aspects, the present disclosure maintains access to existing food and water sources found in standard rodent housing conditions without need for additional food or water sources.

In some aspects, the technology divides space in a cage for vertebrate animals to help reduce aggression in laboratory animals.

In some aspects, cage divider is held in place by the cage's feed hopper and/or lid.

In some aspects, the cage divider does not interfere with the animals' ability to obtain food or water, or the researcher's or animal care person's ability to observe the animals.

In some aspects, the technology helps to reduce costs to maintain animals in a facility.

In some aspects, the technology described herein may be used to separate laboratory animals placed in the same cage to reduce maintenance costs.

In some aspects, the technology described herein may be sold to the public for customers who want to have more than one mouse/rat as a pet.

In some aspects, the technology described herein may improve research by reducing the likelihood of animal models becoming injured.

In some aspects, the divider can be applied to animal cages in research facilities instead of current dividers and separation systems, which are targeted more towards pet owners.

In some aspects, the technology described herein may save money by reducing the number of separate pans needed for maintaining animals.

In some aspects, the technology can be applied to pet owners of mice and rats and not solely targeted towards researchers or animal care facility employees. In some embodiments, the technology can be scaled up and used for other larger animals such as dogs or cats that express aggression in grouped areas such as in adoption centers.

In some aspects, the technology can be sold to companies who manage a variety of animal models. The companies that create and sell specific genetically mutated mice/rats can use the technology to reduce the number of pans necessary to maintain mice/rat colonies.

In some aspects, the technology is most useful and applicable for researchers and laboratories.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a photograph of a first embodiment of a housing for a rodent population. As shown in FIG. 1, the housing has a “common room” or “common milieu”, and segregated individual nesting areas or “burrows.”

FIG. 2 is a photograph of a second embodiment of a housing for rodent population that also shows a “common room” or “common milieu”, and segregated individual nesting areas or “burrows.”

FIG. 3 is a photograph of a second embodiment of a housing for rodent population that also shows a “common room” or “common milieu”, and segregated individual nesting areas or “burrows.”

FIG. 4 is a photograph of a second embodiment of a housing for rodent population that also shows a “common room” or “common milieu”, and segregated individual nesting areas or “burrows.”

FIG. 5 is a bar graph that shows a recorded number of aggressive events per time.

FIG. 6 is a graph that shows event severity based on 1) posturing (e.g., sparring, tail-thump, mounting, barking, pouncing, and chasing), 2) scuffling, 3) biting, 4) blood, and 5) severe injury for both rodent population in a non-divided cage and a divided cage.

FIG. 7 is a bar graph that shows a recorded event frequency per hour for a rodent population in a non-divided cage and a rodent population in a divided cage.

FIG. 8 is a top view of an embodiment of a system for reducing aggression within a small animal population.

### DETAILED DESCRIPTION OF CERTAIN INVENTIVE EMBODIMENTS

In their natural habitat, male mice (Mus musculus) live in despotic social groups existing of one dominant male, females with their progeny, and subordinate males. The dominant male defends his territory containing resources such as females, food and a nest site. Familiar subordinate males are generally tolerated inside the territorial boundaries (see, Mackintosh J H (1970) Animal Behaviour 18, 177-83; Mackintosh J H (1973) Animal Behaviour 21, 464-70; Hurst J L, et al., (1993) Animal Behaviour 45, 997-1006). Intermale aggression within a socially stable group may be part of a broader behavioral strategy, in which all behavior of an animal is aimed at a broader goal, namely to be fittest for a specific environment (see, Benus R F, et al., (1990) Behavioural Processes 21, 127-41; Benus R F, et al., (1990) Behaviour 112, 176-93; Benus R F et al., (1991) Experientia 47, 1008-19; Sluyter F, et al., (1995) Behavior Genetics 25, 247-52). In the wild, mice show rhythmic population numbers, going up to a certain optimum level, followed by a rapid decline and an increase to the optimum again. It appears that when mice are living in small numbers, it is beneficial to possess a ‘sturdy’ character. Sturdy involves being aggressive and less flexible, showing routine-like behavior, which enhances the chance of survival. When population size increases, however, it is beneficial to be more flexible. It appears that in the wild, mice of the more flexible type will migrate to unfamiliar grounds, and will be more successful in finding and maintaining a new territory.

Although potentially damaging, aggression can be regarded as having beneficiary effects in the short run. In such situations, physiological and behavioral mechanisms at work within and between animals prevent aggression from escalating to levels that are actually damaging. When male mice are group-housed in the laboratory, a certain level of intermale aggression can thus be regarded as normal or natural (see, Bisazza A (1981) Bollettino Zoologica 48, 157-67; Brain P F, Parmigiani S (1990) Biological Journal of the Linnean Society 41, 257-69). However, aggression levels may be so high that the welfare of the animals is jeopardized (see, Brain P F, Parmigiani S (1990) Biological Journal of the Linnean Society 41, 257-69; Van Oortmerssen G A (1971) Behaviour 38, 1-92; Bisazza A (1981) Bollettino Zoologica 48, 157-67).

Knowing this, the National Institute of Health (NIH) and the United States Department of Agriculture (USDA) have established guidelines, regulations and oversight for the care and welfare of laboratory animals. The Office of Laboratory Animal Welfare (OLAW) enforces the policies and guidelines set forth by the NIH. The USDA, enforces regulations set forth by the Animal Welfare Act (AWA) for itemized USDA covered species such as hamsters, gerbils, guinea pigs, and specific strains of rats and mice. Both NIH and OLAW rely upon the Association for Accreditation of Laboratory Animal Care (AALAC) and to enforce these and more detailed guidelines for the care and welfare of laboratory animals, including USDA covered species, as well as institutional programs for animal use. Accreditation by AALAC is voluntary however, is required to receive any NIH funding. The USDA has the authority to fine and/or shut down institutions that fail to adhere to the AWA. Both USDA regulations and AALAC accreditation requirements include the routine monitoring of rodents for aggression. When encountered, standard practice is to add enrichments devices or separate animals. These procedures are ubiquitous throughout federally-funded operations and those using USDA covered species, but only partially accomplish the goal, as outlined below.

Previous attempts to prevent such aggression have involved the segregation of mice in separate housing or the use of transparent barriers. However, the lack of opportunity to interact with conspecifics greatly influences the behavior and physiology of both mice and rats and has frequently been referred to as ‘isolation stress’ or ‘isolation syndrome’. Animals that suffer from ‘isolation syndrome’ are more difficult to handle and become more aggressive, sometimes show stereotyped behavior patterns and may suffer from convulsions. Furthermore, several studies indicate that individual housing induces reduction of stress resistance and immunocompetence, higher tumour incidence, hypersensitivity to toxic agents and increased pathology such as ‘scaly tail’ (see, Chance M R A, Mackintosh J H (1962) The effects of caging. In: Collected Papers Vol. 11: The Environment of Laboratory Animals (Laboratory Animals Centre, MRC Laboratories). Surrey: Carshalton, pp 59-64; Ader R, Friedman S B (1964) Psychological Reports 15, 535-41; Hatch A M, et al., (1965) Toxicology and Applied Pharmacology 7, 737-45; Barrett A M, Stockman M A (1966) Nutrition Reviews 24, 116-19; Gartner K (1968) Deutsche Tierarztliche Wochenschrift 2, 45-8; Gartner K (1968) Deutsche Tierarztliche Wochenschrift 4, 97-100; Baer H (1971) Laboratory Animal Science 21, 341-9; Brain P F (1975) Life Sciences 16, 187-200; Haseman J K, Bourbina J, Eustis S L (1994) Fundamental and Applied Toxicology 23, 44-52). Accordingly, it is evident that individually-housed animals differ from socially-housed animals in behavioral, neuro-endocrinological and neuro-physiological parameters, and as such may not be appropriate as a research model.

Previous attempts to prevent such aggression have involved frequent cage cleaning. However, cage cleaning, although essential for hygiene, disrupts odor cues and stimulates activity, leading to an increase in aggression as animals re-establish dominance (see, Gray S, Hurst J L (1995) Animal Behaviour 49, 821-6; Rodent Refinement Working Party (1998) Laboratory Animals 32, 233-59).

Previous attempts to prevent such aggression have involved adding complexity within the actual housing. In the majority of cases, the increase of complexity or the addition of environmental enrichment enhanced the well-being of the mice being studied. For male mice, however, several studies report an increase in aggression when cages are more complex (see, McGregor P K, Ayling S J (1990) Applied Animal Behaviour Science 26, 277-81; Haemisch A, Gartner K (1997) Acta Physiologica Scandinavica 161(suppl. 640), 73-6).

The present disclosure provides a solution for excessive aggression in small animal populations, such as group-housed rodents. Indeed, experiments conducted during the course of developing embodiments for the present disclosure determined the storing of animals (e.g., mice) in a housing area having 1) a common milieu area and 2) segregated individual nesting areas resulted in reduced aggression among the mice in comparison to mice stored in housing areas having only a common milieu area.

Aggression in the present disclosure may include hostile, violent, forceful, attacking, aloof, assertive or territorial behaviors that manifest between members within a small animal population. For example, these behaviors may include one or more of posturing (including, for example, sparring, tail-thump, mounting, barking, pouncing, and chasing), scuffling, biting, blood, and severe injury.

Laboratory animals spend the vast majority of their life in their home cage. It is in the interest of both the animals and the researcher that in this home cage an environment is created that provides for the animals' physiological and ethological needs. When the greatest care for animal welfare is provided, the animals will then respond more uniformly, more reliably to experimental protocols, and thereby experimental results will be more reliable. For these reasons, research into housing conditions for laboratory animals that also take into account experimental, economic, and ergonomic preconditions is highly prioritized.

The present standardized housing of laboratory animals often fulfils the needs of its inhabitants only marginally. As a result, the animals may behave abnormally and their well-being may be compromised. One of the problems often encountered in laboratory animal facilities is excessive aggression in group-housed male mice. Since mice comprise a high number of all animals used in research, a solution to this problem would have great impact on a large number of animals (see, Van Loo, et al., (2003) Laboratory Animals 37, 300-313).

The present disclosure addresses this need. Indeed, experiments conducted during the course of developing embodiments for the present disclosure determined the storing of animals (e.g., mice) in a housing area having 1) a common milieu area and 2) segregated individual nesting areas resulted in reduced aggression among the mice in comparison to mice stored in housing areas having only a common milieu.

Accordingly, the present disclosure provides housing, systems, kits and methods for reducing aggression among laboratory rodents stored within a common housing. In particular, the present disclosure provides housing, systems, kits and methods related to a laboratory rodent housing having 1) a common milieu area and 2) segregated individual nesting areas.

In certain embodiments, the present disclosure includes various types of rodent housing including a common milieu area and two or more segregated individual nesting areas. In some embodiments, each of the two or more segregated individual nesting areas are separated by dividing walls. In some embodiments, the rodent housing further includes a common water and food area. In some embodiments, the dividing wall is opaque. In some embodiments, the dividing wall is configured to provide line-of-sight evasion between a dominant small animal on a first side of the dividing wall and a subordinate small animal on a second side of the dividing wall. In some embodiments, if a dominant small animal is within line-of-sight of a submissive small animal then the dominant small animal will exhibit aggressive behaviors.

In some embodiments, the housing is transparent. In some embodiments, the dividing walls are transparent. In some embodiments, the material composition of the housing and the dividing walls is plastic.

Such rodent housing embodiments are not limited to a particular number of segregated individual nesting areas. In some embodiments, the number of segregated individual nesting areas is less than 10. In some embodiments, the number of segregated individual nesting areas is less than 5. In some embodiments, the number of segregated individual nesting areas is 3.

Such rodent housing embodiments are not limited to housing a particular type of rodent. In some embodiments, the rodents include, but are not limited to, rats, mice, guinea pigs, hamsters, etc. In some embodiments, the rodents are laboratory rodents. In some embodiments, the rodents are pet rodents.

In certain embodiments, the present disclosure provides methods of reducing aggression within rodents residing within group housing, including providing a housing as described above, and domiciling two or more rodents within the housing. In some embodiments, the number of domiciled rodents has no relation to the number of segregated individual nesting areas. In some embodiments, the number of rodents equals the number of segregated individual nesting areas. In other embodiments, the number of rodents or the number of segregated individual nesting areas is greater than the other.

In some embodiments, the housing is generated through modifying a rodent housing having only a common milieu, wherein the conversion includes positioning of dividing walls within the rodent housing having only a common milieu such that two or more segregated individual nesting areas are generated.

In certain embodiments, the present disclosure provides dividing walls for modifying a rodent housing having only a common milieu, wherein each dividing wall is configured for positioning within a rodent housing having only a common milieu such that segregated individual nesting areas are generated.

In certain embodiments, the present disclosure provides kits including of one or more of such dividing walls and a rodent housing having only a common milieu.

In some embodiments, the present disclosure maintains access to existing food and water sources found in standard rodent housing conditions without need for additional food or water sources.

Accordingly, the present disclosure provides housing, systems, kits and methods for reducing aggression among laboratory rodents stored within a common housing. In particular, the present disclosure provides housing, systems, kits and methods related to a laboratory rodent housing having 1) a common milieu area and 2) segregated individual nesting areas.

The present disclosure is not limited to a particular type or kind or configuration for the housing. In some embodiments, the housing is sized such that a desired number of laboratory animals (e.g., rodents) can reside within the housing. For example, in some embodiments, the housing is sized such that anywhere from 2, 3, 4, 5, 6, 7, 8, 9, 10, 15, 20, 50, 100, etc. laboratory animals (e.g., rodents) can reside within the housing.

The housing is not limited to a particular type of laboratory animal residing within the housing. Generally, the housing is designed for housing rodents. Examples of rodents include, but are not limited, to mice, rats, hamsters, guinea pigs, etc.

The housing is not limited to a particular exterior shape or design. In some embodiments, the exterior shape or design of the housing is cube shaped or rectangular cube shaped. In some embodiments, the exterior shape or design of the housing is similar to traditional laboratory housing (e.g., cages, etc.).

In some embodiments, the housing is developed with a sturdy plastic or fiberglass. In some embodiments, the housing is transparent.

In some embodiments, the present disclosure provides a housing having 1) a common milieu area and 2) segregated individual nesting areas. Such devices are not limited to a particular configuration. In some embodiments, the device has a common feeding area, a common milieu and segregated individual nesting areas.

The common milieu is not limited to a particular size within such housing. In some embodiments, the common milieu is large enough to permit the number of laboratory animals (e.g., rodents) residing within the housing the ability to freely ambulate within the housing common milieu.

The segregated individual nesting areas are not limited to a particular number within such housing. In some embodiments, the number of segregated individual nesting areas is the same as the number of laboratory animals (e.g., rodents) residing within the housing.

The segregated individual nesting areas are not limited to a particular size or configuration. In some embodiments, the segregated individual nesting areas are sized such that a laboratory animal (e.g., rodent) can comfortably enter and exit and comfortably dwell within the segregated individual nesting area. In some embodiments, each of the segregated individual nesting areas are separated by dividing walls. In some embodiments, each of the segregated individual nesting areas can be accessed directly from another segregated individual nesting area, without first entering the common milieu.

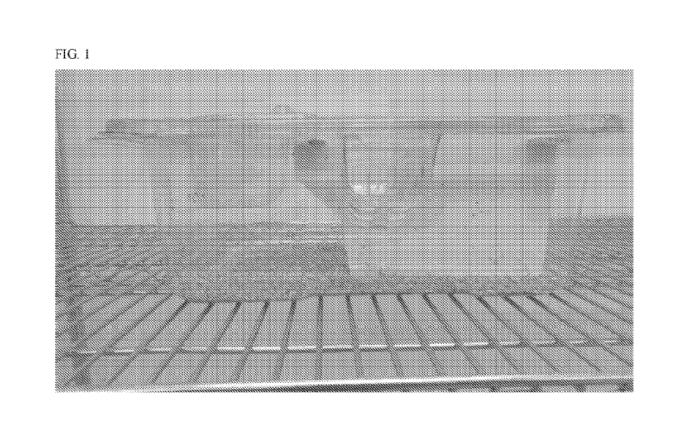

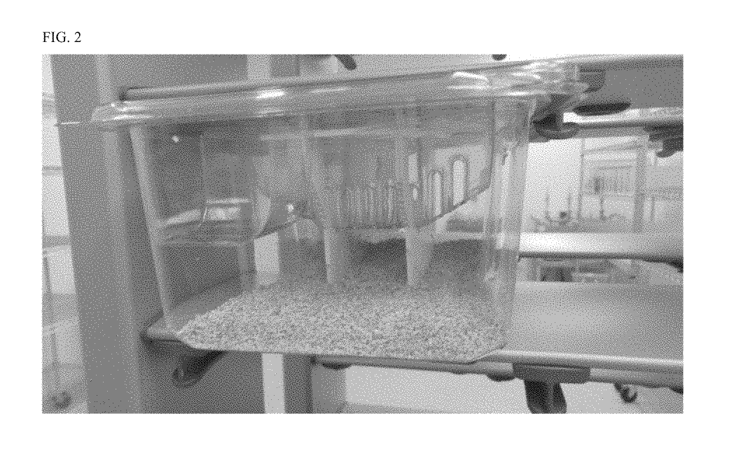

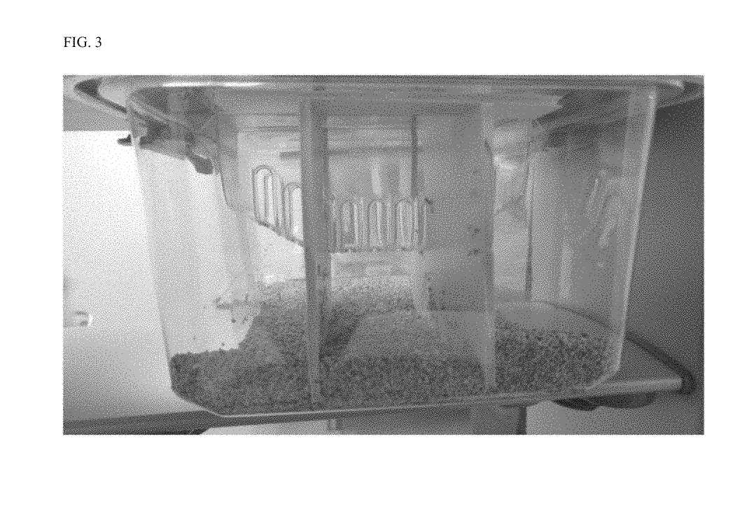

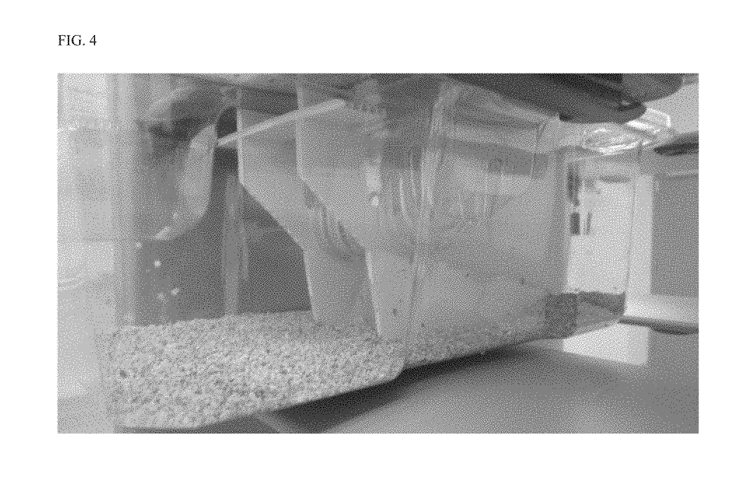

FIGS. 1-4 show different perspectives of housing embodiments according to the present disclosure. As can be seen, each housing has a “common room” or “common milieu”, and segregated individual nesting areas or “burrows” separated by dividing walls.

As noted above, experiments conducted during the course of developing embodiments for the present disclosure determined that mice residing within a housing as described herein experienced reduced aggression in comparison to mice residing within a traditional housing.

As such, the present disclosure further provides methods for reducing aggression within laboratory animals (e.g., rodents) residing within a housing through providing a housing having 1) a common milieu area and 2) segregated individual nesting areas, and domiciling a plurality of laboratory animals (e.g., rodents) within the housing, wherein the number of laboratory animals (e.g., rodents) residing within the housing is equal to the number of segregated individual nesting areas.

In certain embodiments, the present disclosure provides dividing walls for converting traditional laboratory housing having only a common milieu area into a housing having both 1) a common milieu area and 2) segregated individual nesting areas.

Such dividing walls are not limited to a particular shape or design. In some embodiments, the shape or design of the dividing walls are such that each can be positioned within a traditional laboratory housing in a manner which not only retains a common milieu area but further generates segregated individual nesting areas. In some embodiments, the dividing walls are configured to not impede airflow or access to food and water.

In some embodiments, the dividing wall is an insert that is held in place by the original housing's feed hopper and/or lid, and has primary benefits on animal welfare. Indeed, as noted, experiments conducted during the course of developing embodiments for the present disclosure indicate that the presence of such dividing walls reduce aggression among laboratory animals, thereby improving animal welfare.

In some embodiments, dividing walls are designed to provide a burrow-like environment, appear to be psychologically larger, and provide for more physical activity. The dividing walls effectively separate the original housing having only a common milieu into four areas without decreasing floor space or impairing daily observations and health checks by animal care personnel. The dividing walls do not impede airflow or access to food and water.

The dividing walls provide a simple, cost effective means to improve the animals' welfare and reduce aggression for everyday housing of vertebrate animals. One particular use may be in the housing of laboratory mice for research. These dividing walls reduce experimental variability between animals and improve scientific rigor of studies, particularly by maintaining a social housing environment.

Such dividing walls are not limited to a particular material composition. In some embodiments, the material composition of the dividing walls includes paper, cardboard, corrugated plastic (e.g., disposable), polycarbonate (e.g., reusable), fiberglass, etc. In some embodiments, the dividing walls are transparent. In some embodiments, the design of the dividing walls is constructed from a single piece of corrugated plastic that folds in two places and fits into the slots of the feed hopper of the Innovive™ mouse cage (see, FIGS. 1-4). In some embodiments, the dividing walls are formed of cardboard or corrugated paper or corrugated cardboard. In some embodiments, s dividing walls can be stored flat and then folded upon insertion to the cage. In some embodiments, the dividing walls can be of any shape or design for purposes of positioning within any existing housing having only a common milieu. In some embodiments the dividing walls are opaque. In some embodiments, the number of dividing walls is 1, 2, 3, 4, 5, 6, 7, 8, 9, 10, 11, 12, 13, 14, 15, 16, 17, 18, 19, 20 or more or any number or range defined therebetween.

In certain embodiments, the present disclosure provides methods for reducing aggression within laboratory animals (e.g., rodents) residing within a housing through providing a housing having only a common milieu area and one or more dividing walls tailored for positioning within the housing having only a common milieu, positioning the one or more dividing walls within the housing, wherein the positioning results in a housing having both a common milieu area and segregated individual nesting areas, and domiciling a plurality of laboratory animals (e.g., rodents) within the housing, wherein the number of laboratory animals (e.g., rodents) residing within the housing has no relation to the number of segregated individual nesting areas.

In certain embodiments, the present disclosure provides kits for reducing aggression within laboratory animals (e.g., rodents) residing within a housing having only a common milieu area, including providing one or more dividing walls tailored for positioning within the housing having only a common milieu.

Evaluation of previous devices yields no results with the same features. A current standard of care for increasing the enrichment of vertebrate animals is the Nestlet™. The Nestlet™ is a square of compressed cotton used to build a nest, but has the unintended consequence of creating a scarce resource between animals, and therefore a hierarchy. When the hierarchy is challenged, aggression results. In experiments conducted during the course of developing embodiments for the present disclosure, Nestlets were included in both the standard and divided cages, and a 3 fold reduction in aggressive events within the divided cages compared to standard caging was demonstrated.

The housing embodiments of the present disclosure (e.g., including housings modified using the dividing walls of the present disclosure) further represent improvements over housings having a “hut” or tunnel. While housings having a “hut” or tunnel offer some compartmentalization, these objects are not favored by laboratory animal staff, because the most commonly used “hut” is an opaque disposable product with a small hole in the front. This device prevents visualization of the animals and requires animal care staff and research personnel to remove the cage from the rack, open it, and remove the “hut” to observe the animals. Some huts come in tinted transparent non-disposable materials however, when the nesting material is used within the hut, it has the same effect as an opaque wall hut.

On the contrary, housing embodiments of the present disclosure (e.g., including housings modified using the dividing walls of the present disclosure) have walls the height of the cage with “burrows” that open into an open area. Even with nesting material, clear lines of sight remain to observe the animals without opening the cage.

### EXAMPLES

The following examples are illustrative, but not limiting, of the compounds, compositions, and methods of the present disclosure. Other suitable modifications and adaptations of the variety of conditions and parameters normally encountered in research protocols and which are obvious to those skilled in the art are within the spirit and scope of the disclosure.

### Example I

This example is based upon the hypothesis that cage dividers, which provide burrows and common access to food/water for mice, are a simple, cost-effective means to reduce aggression in group-housed mice.

### Materials

Mice:

Balb/c male mice at ˜8 weeks of age were used because they are a commonly used strain, somewhat aggressive, and white in color (for easier tracking of individuals).

Divided Cages:

The dividers were made from corrugated plastic and designed to fit inside existing cages without modification to the enclosure, while effectively dividing the cage into four areas without decreasing floor space or impairing daily observation and health checks by animal care personnel.

Aim 1 determined how the animals' behavior differs between divided caging and non-divided caging with respect to more natural mouse behavior, the group dynamic, and their interactions with each other. Data collected included: time of each animal in a solitary room, time of each animal in the common area, time of each animal alone, and time of each animal with one or more cage mates.

Aim 2 monitored aggression within each cage, and determines the number of incidents in divided vs open cages. Data collected included: the number and severity of fights.

Animal Numbers:

The same animals were used for both aims. 3 mice×3 cages×2 groups [standard caging; divided caging]=18 mice; n=3 cages per group.

### Methods

Mice were divided into two groups.

Group 1 were housed in standard caging (no dividers).

Group 2 were housed in standard caging with the addition of solid wall cage dividers.

Each cage housed three animals, offering the divided cage animals access to their “own space”, and a common area. A camera was positioned at the rear of each cage to record the animal's behavior. 12 hours per session were recorded starting upon receipt, 24 hours later, and seven days later.

All recordings began with 6 hours remaining in the light cycle and continued at least 6 hours into the dark cycle.

Scoring was based upon the following behavior: 1) posturing (e.g., sparring, tail-thump, mounting, barking, pouncing, and chasing), 2) scuffling, 3) biting, 4) blood, and 5) severe injury.

### Results

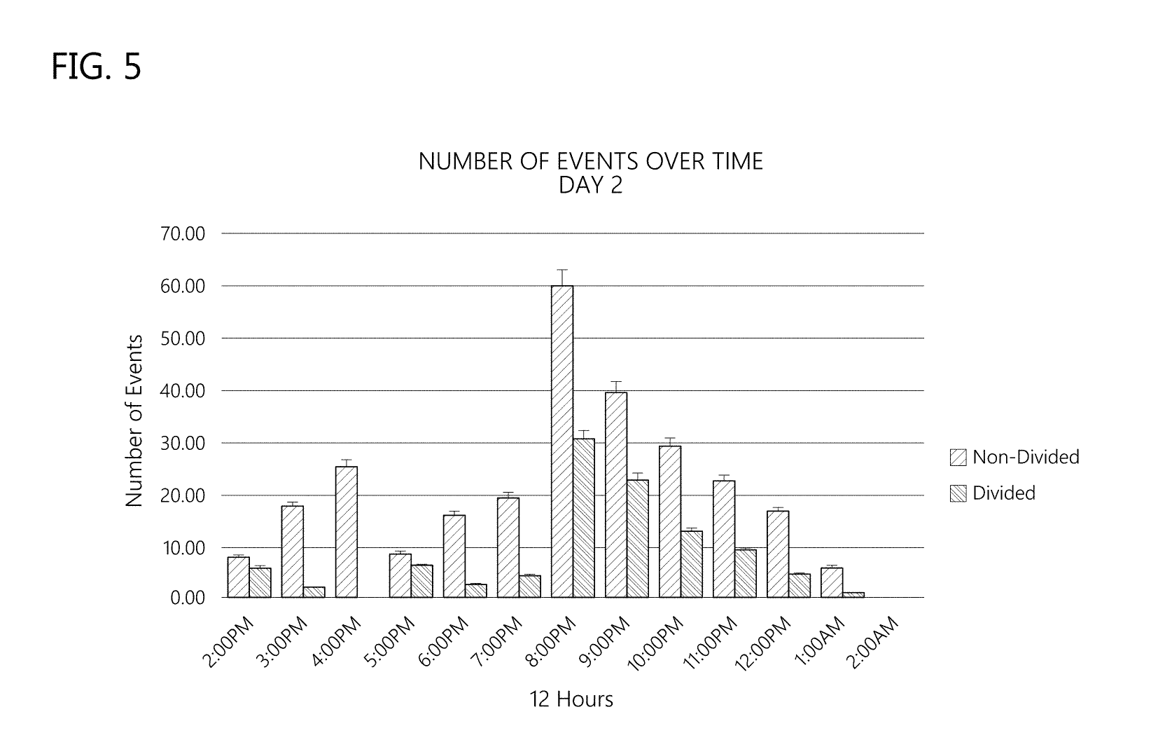

FIG. 5 shows the number of aggressive events per time. As can be seen in FIG. 5, there was an increase in aggressive events at the beginning of the dark cycle (8:00 pm), and a gradual decrease over the next six hours. Animals in the divided cage had significantly fewer aggressive interactions than those in the open cage.

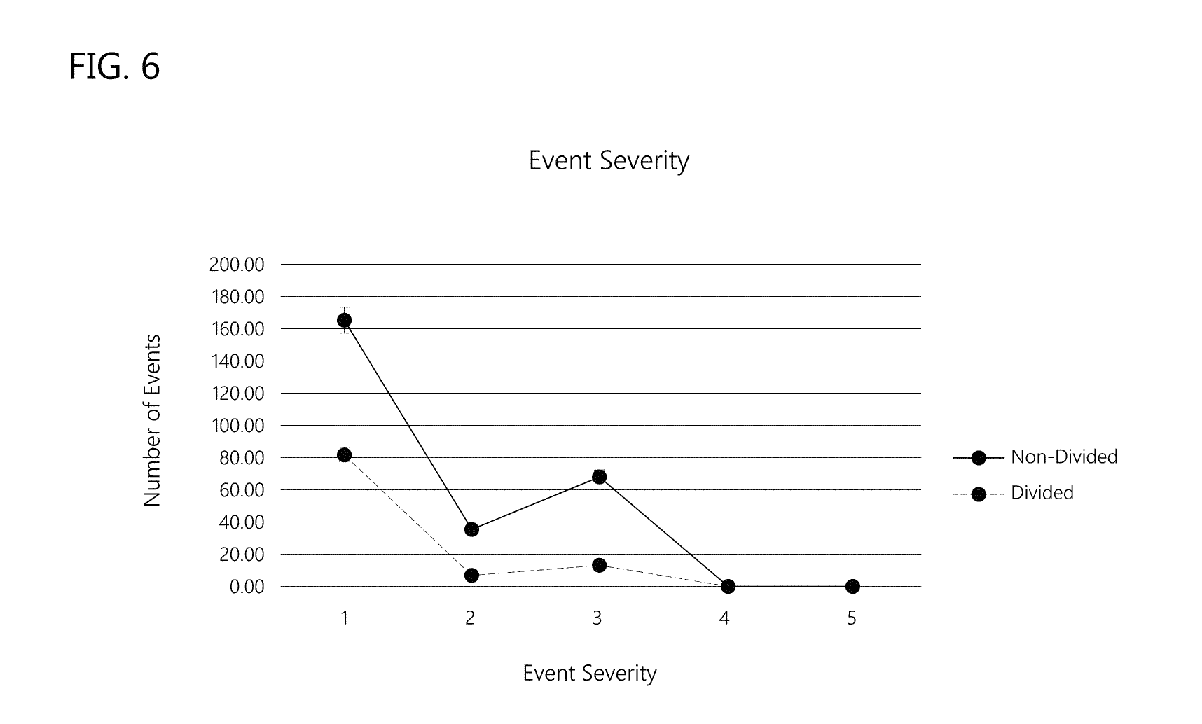

FIG. 6 shows event severity based on 1) posturing (e.g., sparring, tail-thump, mounting, barking, pouncing, and chasing), 2) scuffling, 3) biting, 4) blood, and 5) severe injury.

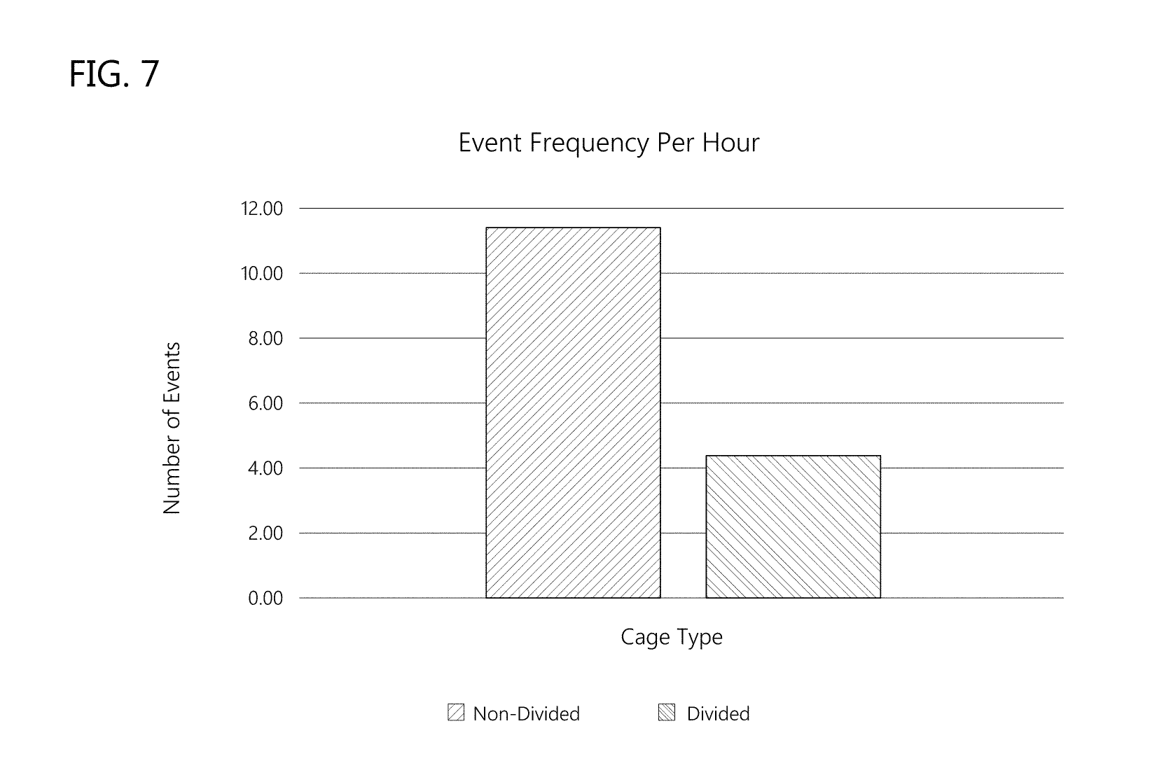

FIG. 7 shows the event frequency per hour.

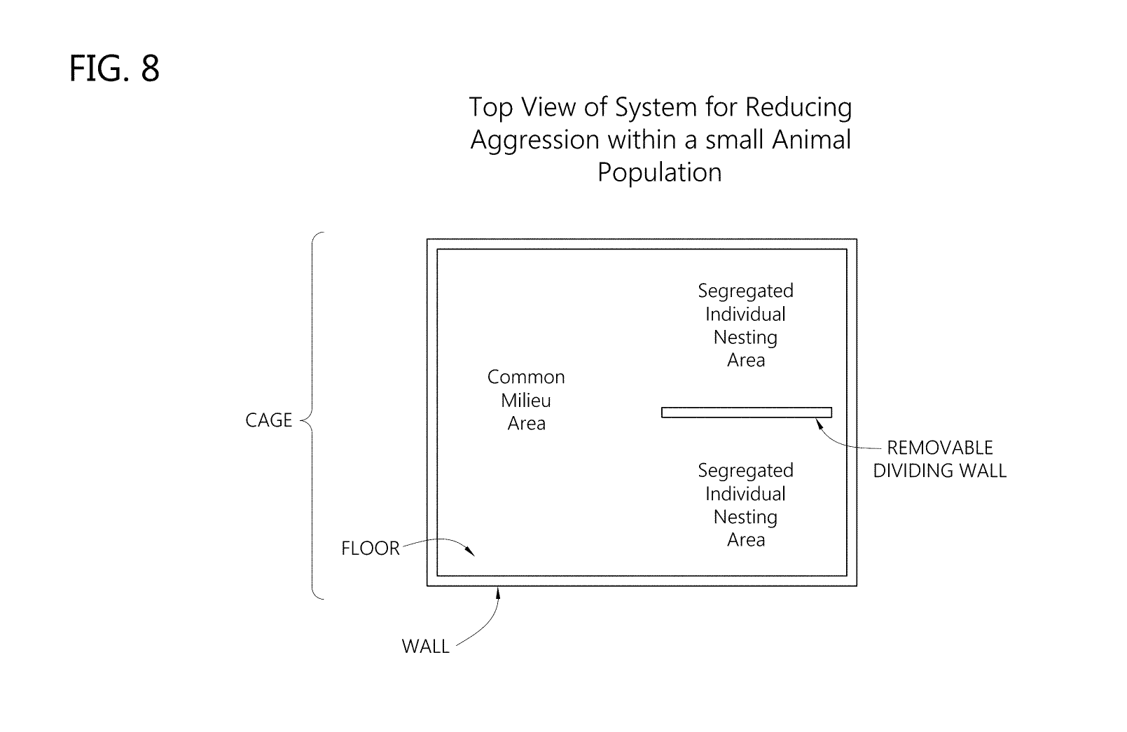

FIG. 8 illustrates a top view of a system for reducing aggression within a small animal population. The system includes a cage having a floor surrounded by a perimeter wall. Within the perimeter wall is a common milieu area where the small animals may interact. Also within the perimeter wall is a removable dividing wall that separates two segregated individual nesting areas. In some embodiments, the removable dividing wall is formed of an opaque material such as a paper or cardboard to provide line-of-sight evasion from a dominant small animal in a first of the two segregated individual nesting areas to a subordinate small animal in the second of the two segregated individual nesting areas. In some embodiments, cotton mats, toilet paper rolls, etc. are placed within the cage for the small animals to chew on and entertain themselves. In some embodiments, the small animals chew on the removable dividing walls. In some embodiments, the small animals use pieces of the removable dividing walls for nesting materials. In some embodiments, the removable dividing walls can be completely chewed or used by the small animals within a span of two weeks. In some embodiments, the small animals are rodents. In some embodiments, the small animals are mice. In some embodiments, more than one dividing wall is present, which creates more than two segregated individual nesting areas. In some embodiments, the number of dividing walls is 1, 2, 3, 4, 5, 6, 7, 8, 9, 10 or more or any number or range therebetween.

While this invention has been described in connection with what is presently considered to be practical exemplary embodiments, it will be appreciated by those skilled in the art that various modifications and changes may be made without departing from the scope of the present disclosure. It will also be appreciated by those of skill in the art that parts mixed with one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the invention is not limited to the disclosed embodiments, but, on the contrary, is intended to cover various modifications and equivalent arrangements included within the spirit and scope of the appended claims, and equivalents thereof.

### INCORPORATION BY REFERENCE

The entire disclosure of each of the patent documents and scientific articles referred to herein is incorporated by reference for all purposes. U.S. Provisional Application No. 62/355,584, filed on Jun. 28, 2016, which is relied upon by the present application for priority is also hereby expressly incorporated by reference in its entirety.

1. A system for reducing aggression within a small animal population, the system comprising:
a cage configured to house two or more small animals, the cage including a floor and walls extending substantially perpendicular from the floor;
a common milieu area within the cage;
two segregated individual nesting areas within the cage; and
a removable dividing wall positioned within the cage substantially perpendicular to the floor and separating the two segregated individual nesting areas from each other.

2. The system of claim 1, wherein the cage is transparent.

3. The system of claim 1, wherein the dividing wall is transparent or translucent.

4. The system of claim 1, wherein the dividing wall is opaque, and wherein the dividing wall is configured to provide line-of-sight evasion between a dominant small animal on a first side of the dividing wall and a subordinate small animal on a second side of the dividing wall.

5. The system of claim 1, further comprising a lid affixed to the top of the walls of the cage.

6. The system of claim 5, wherein the lid is transparent.

7. The system of claim 1, wherein the floor comprises a substantially flat surface.

8. The system of claim 1, wherein the floor is substantially rectangular.

9. The system of claim 1, wherein the walls extended substantially perpendicular upward from the floor.

10. The system of claim 1, wherein the walls extend upward from the floor such that the perimeter of the top of the walls is larger than the perimeter of walls where they attach to the floor.

11. The system of claim 1, wherein the dividing wall has a hole between the two segregated individual nesting areas.

12. The system of claim 1, further comprising a common water and food area.

13. The system of claim 1, wherein the removable dividing wall is formed in a substantially rectangular plate shape.

14. The system of claim 1, wherein the removable dividing wall is formed of cardboard or corrugated paper or corrugated cardboard.

15. The system of claim 1, wherein both the cage and the dividing walls are formed of plastic.

16. The system of claim 1, wherein an edge of the removable dividing wall contacts one of the walls in a substantially perpendicular fashion.

17. The system of claim 1, wherein an edge of the removable dividing wall is positioned substantially perpendicular to, but does not contact, one of the walls.

18. The system of claim 1, wherein the removable dividing wall is held in place by a feed hopper.

19. The system of claim 1, wherein the removable dividing wall is held in place by the lid.

20. The system of claim 1, wherein each of the two segregated individual nesting areas includes a square of compressed cotton.

21. The system of claim 1, wherein the two segregated individual nesting areas each have access to the common milieu area within the cage such that a first small animal from the small animal population can pass from the common milieu area into either of the two segregated individual nesting areas.

22. The system of claim 1, wherein the two segregated individual nesting areas are connected by the common milieu area within the cage.

23. The system of claim 1, wherein the small animal is a rodent.

24. The system of claim 23, wherein the rodent is selected from the group consisting of a rat, a mouse, a hamster and a guinea pig.

25. The system of claim 1, wherein the small animal is a mouse.

26. A method of reducing aggression between rodents residing within a housing, the method comprising:
providing a transparent housing having a floor with border walls attached to and extending upwardly from the floor, the transparent housing having a common milieu area and two individual nesting areas; and
placing two or more rodents within the housing, wherein the number of domiciled rodents has no relation to the number of segregated individual nesting areas.

27. The method of claim 26, further comprising placing a removable wall between the two individual nesting areas, the removable wall formed in a plate shape and positioned substantially perpendicular to the floor and substantially perpendicular to one of the boarder walls.

28. The method of claim 27, wherein the removable wall does not contact the one of the border walls.

29. The method of claim 26, further comprising placing a square of compressed cotton in each of the two individual nesting areas.

30. The method of claim 26, wherein the removable wall is formed of a corrugated paper, cardboard or corrugated cardboard such that the rodents may chew on the removable wall and/or make additional nesting material from the removable wall.

31. The method of claim 26, wherein the removable wall is configured to provide line-of-sight evasion from a dominant rodent within one of the segregated individual nesting areas and at least one of the remaining segregated individual nesting areas.

32. A dividing wall for modifying a rodent housing having only a common milieu, wherein the dividing wall is configured for positioning within a rodent housing having only a common milieu such that segregated individual nesting areas are generated.

33. A kit, comprising:
a rodent housing having a floor and border walls defining an inner perimeter;
a common milieu within the inner perimeter;
a lid for placing over a top of the rodent housing; and
a removable dividing wall configured for placement within the inner perimeter to define at least two individual nesting areas within the inner perimeter.

34. The kit of claim 33, wherein the removable dividing wall is opaque.

35. The kit of claim 33, wherein the removable dividing wall is configured to be held in place by the lid.

36. A system for reducing aggression within a small animal population, the system comprising:
a cage configured to house two or more small animals, the cage including a floor and walls extending substantially perpendicular from the floor;
a common milieu area within the cage;
three segregated individual nesting areas within the cage;
a first removable dividing wall positioned between a first nesting area of the three segregated individual nesting areas and a second individual nesting area of the three segregated individual nesting areas; and
a second removable dividing wall positioned between the second individual nesting area of the three segregated individual nesting areas and a third individual nesting area of the three segregated individual nesting areas.
